(19) United States
(12) Patent Application Publication
(10) Pub. No.: US 2001/0025602 A1
(43) Pub. Date: Oct. 4, 2001

(54) Apparatus and process for balancing a rotating body by material addition

(76) Inventor: Gianni Trionfetti, Agrate Brianza (Milan) (IT)

Correspondence Address: BROWDY AND NEIMARK, P.L.L.C., 624 NINTH STREET, NW, SUITE 300, WASHINGTON, DC, 20001-5303, US

(21) Appl. No.: 09/816,208

(22) Filed: Mar. 26, 2001

(30) Foreign Application Priority Data
Mar. 31, 2000 (IT) MI2000A 000690

(51) Int. Cl. B05D 5/00

(52) U.S. Cl. 118/319

(57) ABSTRACT

An apparatus (1) for balancing a rotating body by material addition is disclosed which comprises dispensing means for supplying a balancing material to be applied to the rotating body, the balancing material consisting in a semifluid product (6) susceptible of being dried, as a not yet polymerized resin, and the apparatus comprising a dispensing unit (7) for dispensing measured quantities (9) of the not yet polymerized resin on the rotating body, and a stabilizing unit (14) for catalyzing the polymerization of the resin after dispensing of the same.

### FIELD OF THE INVENTION

The invention relates to an apparatus and process for balancing a rotating body by material addition, in particular for balancing fans and motor fans, of the type comprising dispensing means for supplying a balancing material to be applied to at least one region of the rotating body.

### DESCRIPTION OF THE PRIOR ART

It is known that fans, usually of plastic material, are greatly in use in the field of civil and industrial ventilation.

For instance, they are produced to a great amount for the motor-vehicle sector, where they are employed for radiator cooling, air conditioning and forced ventilation at the inside of cars.

The concerned fans often have high rotation speeds and their sizes and conformations are of the most different types.

In fact, even if the motor-vehicle sector alone is taken into account, it is possible to distinguish thin fans (of a thickness included between about 15 and about 30 mm), with a great diameter (just as an indication, of 250 to 500 mm) and with a small number of blades (4 to 10), typically used for radiator cooling, and fans having an important thickness (about 30 to 100 mm), a much smaller diameter (250 mm at most) and a high number of blades (greater than 20), typically employed for forced ventilation at the inside of cars.

In order to avoid vibrations that may cause troublesome noise, damages to the supporting structures, malfunction, and a reduced lifetime, said fans must be carefully balanced.

However, due to their major structure of plastic material and the great variety of sizes, a balancing based on completely automated processes has been hitherto hindered.

Practically, balancing relies both on a good planning of the molds and, after final assembling of the fans, on a rough and partly manual correction carried out by merely adding metal clips onto the blades of plastic material. Clips are produced with different weights so that they can reach a sufficiently precise balancing.

The drawbacks present in the above mentioned known art are quite clear.

A first drawback is connected with a partial manual character of the balancing operations: said operations need skilled staff, which will bring about high costs and limited production amounts or at all events amounts that cannot be easily extended beyond the stated levels.

A second drawback is linked to the fact that manual interventions and use of added material having discontinuous and pre-established weights, such as clips, give rise to balancing operations that are not very accurate.

A third drawback is then linked to the fact that metal clips are foreign elements in the fan body. Therefore they cause a possible noise because they introduce a net and stepped unevenness into the fan shape. In addition they introduce a point of particular wear due to the important discontinuity in the fan structure and in the distribution of stresses at high rotation speeds. Wear is emphasized by the fact that clips are of metal material and therefore their values and characteristics of resistance to environmental stresses are quite different from those of the plastic material of which fans are made.

Up to now the above drawbacks did not seem capable of being remedied because the structural and dimensional multiplicity of the fans to be balanced has hindered accomplishment of apparatus capable of efficiently intervening thereon.

In addition, clips appeared to be almost irreplaceable taking into account their relative facility in being manually applied and the fact that, due to thinness of the blades and of the different elements of a fan, a balancing by material removal is made impossible. In fact material removal can be carried out only on rotating bodies of important thickness, as in the case of rotors for electric motors.

### SUMMARY OF THE INVENTION

Still unresolved has been therefore the technical problem of how to carry out balancing of a rotating body such as a fan in a completely automated manner, by material addition.

The task of the present invention is to solve said technical problem.

Within the scope of the above task, it is an aim of the invention to provide an apparatus in which material addition can be carried out in a precise manner, in connection with the measured unbalances.

It is another aim of the invention to provide an apparatus capable in particular of balancing fans of plastic material without introducing either strong discontinuities or noise, or regions of wear in the same.

The task mentioned and the aims specified are achieved by an apparatus for balancing a rotating body by material addition comprising dispensing means for supplying a balancing material to be applied to at least one region of said rotating body, said balancing material consisting in a semifluid product susceptible of being dried, and said dispensing means comprising a dispensing unit for supplying measured quantities of said semifluid product. Suitably a stabilizing unit is provided for drying said semifluid product after it has been dispensed.

Advantageously, said semifluid product is an unpolymerized resin, and a stabilizing unit for catalyzing polymerization of said resin is provided.

The process for balancing a rotating body by material addition consists in locally applying measured quantities of material to be polymerized to said rotating body and in polymerizing said material after application of same to said rotating body.

### BRIEF DESCRIPTION OF THE DRAWINGS

Description of a preferred embodiment of the invention is now given hereinafter, by way of non-limiting example, with reference to the accompanying drawings, in which:

FIG. 1 shows how material addition is carried out;

FIG. 2 diagrammatically shows how balancing in accordance with the invention is carried out as a whole on a fan of plastic material;

FIG. 3 highlights how a fan appears after the balancing operations referred to in the preceding figures; and

FIG. 4 shows a preferred embodiment of the apparatus on the whole, in connection with the components thereof of greater importance.

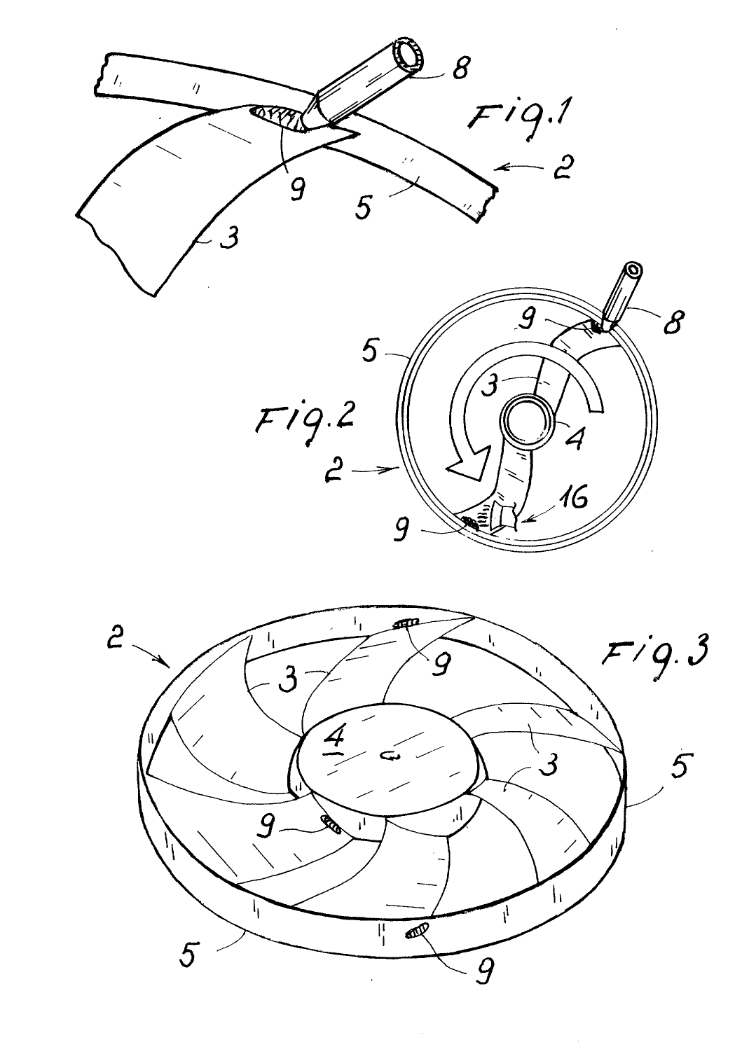

### DESCRIPTION OF THE PREFERRED EMBODIMENT

With reference to the drawings, the apparatus of the invention is generally identified by reference numeral 1.

It is of the type comprising dispensing means adapted to supply balancing material to be steadily applied to at least one region of a rotating body, the latter consisting of a fan or a motor fan of plastic material, for example.

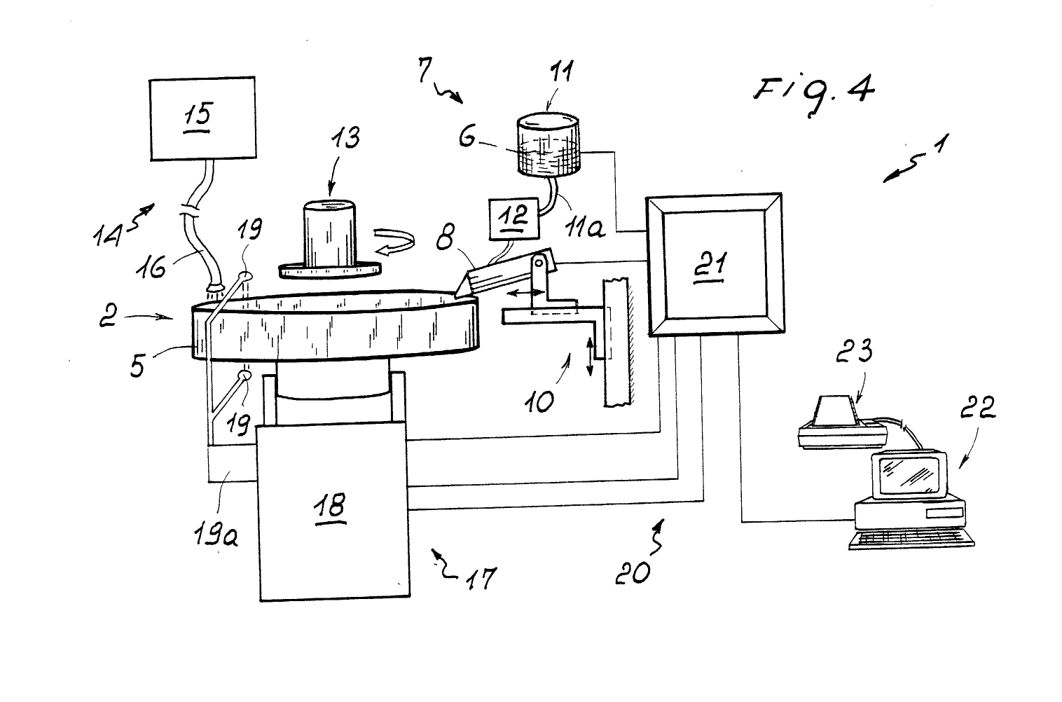

Shown in FIG. 3 is a fan 2 for radiator cooling in motor-vehicles. It is typically a fan of plastic material with a large diameter and reduced thickness, so that balancing in a single plane is required.

Fan 2 has a reduced number of blades 3 (six blades) extending in a radial direction between a hub 4 and a peripheral ring 5.

In this fan 2 the balancing operations by material removal are not appropriate due to thinness of the different elements that could be submitted to yielding if notched or filed, whereas balancing operations by localized added material or addition of balancing material are possible and appropriate.

In accordance with the invention, the balancing material is made up of a semifluid product 6, by this term intending a product of the “creamy”, “pasty” or “viscous” type as regards its consistency or density.

In other words, said semifluid product 6 has a sufficient density to make the dispensed amounts keep the position and shape determined at the dispensing moment, but also such a density that an easy conveying of the product along ducts and channels is allowed when a pressure is applied upstream of said channels.

Moreover, the semifluid product 6 is of a type capable of being easily dried. For instance, a one-component resin, which may be an acrylic, silicone or epoxy resin, not yet polymerized is provided, which can quickly harden by polymerization when polymerization is induced by catalysis.

The dispensing means comprises a dispensing unit 7 capable of supplying the semifluid product 6, i.e. the not yet polymerized resin, in a continuous and measured manner, upon command.

In order to be able to intervene in a precise manner at the regions to be re-balanced of the rotating body or fan 2, the dispensing unit 7 comprises at least one nozzle or tube or spout 8 adapted to dispense measured quantities 9 of the semifluid product 6.

Nozzle 8 is movably carried by a support 10 disposed close to fan 2. Support 10 has slides and articulated joints for example, that enable nozzle 8 to take the most appropriate positioning in space, so that its dispensing end may move close to fan 2 at a point to be re-balanced.

Therefore, fans of any type can be treated and in addition the semifluid product 6 can be caused to adhere to regions of fan 2 that are substantially protected from external contacts. For instance, as shown in FIG. 3, either at the points where blades 3 are joined to hub 4 or to the peripheral ring 5, or externally of the peripheral ring 5.

Also provided in the dispensing unit 7, upstream of nozzle 8, is at least one tank 11 for the semifluid product 6 and at least one feeder device 12 placed along a duct 11 a extending between the lank 11 and nozzle 8. The feeder device 12 is adapted to convey measured quantities of the semifluid product and it consists for example of a plunger device, a pump device with gears, a worm screw means, an air pressure device.

Obviously, device 12 can be positioned in a different manner or integrated with tank 11.

Actuating members are provided for imposing a relative movement between the nozzle 8 and the rotating body or fan 2 when dispensing of the semifluid product 6 is taking place, so that the measured quantities 9 may have the shape of strips, threads or lengths extending in a circumferential position on fan 2.

In this way the measured quantities can vary as regards weight and sizes without interfering with the shape of fan 2, in particular if they are laid down at the corners where blades 3 are jointed to hub 4 or to the peripheral ring 5.

The relative movement is advantageously obtained by substantially keeping the position of nozzle 8 fixed and by rotating fan 2, and said actuating members comprise an angular-positioning member 13 vertically and centrally superposed on the fan.

To avoid forcing actions, interference or jamming during rotation of fan 2, nozzle 8 can be elastically supported.

The angular-positioning member 13, diagrammatically shown in FIG. 4, is driven by an electric motor and is movable in a vertical direction, close to or away from fan 2.

By this technical solution, addition of operating members to support 10 for the purpose of controlling displacement during dispensing is not required and it is not necessary to calculate the dispensing trajectory: this solution is immediately adaptable to fans 2 of any type.

A stabilizing unit 14 is also provided which is susceptible of drying the semifluid product 6 after it has been dispensed.

In the preferred embodiment in which the semifluid product 6 is a resin to be polymerized, the stabilizing unit 14 comprises a source 15 adapted to emit a catalyzing radiation in the direction of the semifluid product 6 already dispensed.

The catalyzing radiation is defined—depending on the resin used—by ultraviolet rays, infrared rays, laser beams, ultrasonic waves. In this way the resin is catalyzed to induce or accelerate polymerization and therefore hardening thereof.

In an original manner, the technical solution highlighted in FIG. 4 shows a source 15 including a ultraviolet lamp communicating with the outside through a bundle of optical fibers 16 that can be freely positioned or moved close to fan 2.

In this way the catalyzing radiation can be conveyed in a precise manner onto the resin to be polymerized, irrespective of the application points of same and the shape and sizes of fan 2.

In addition the catalyzing radiation does not impinge on nozzle 8 and on the resin not yet applied. In fact the bundle of optical fibers 16 appears with its end portion close to a point of fan 2 diametrically opposite to the point where the polymerizing resin is applied.

The applied resin is brought under the catalyzing radiation by the action of the same elements causing laying down of the measured quantities 9 in a threadlike or strip-like shape, in particular by the angular-positioning member 13.

As shown in FIG. 4, a measuring unit 17 is provided which is adapted to detect the amount and position of the unbalances possibly present in fan 2.

In this measuring unit 17 several different elements known by themselves in the rotating-body balancing field are included.

In particular, the measuring unit 17 comprises a detecting base 18 known in the art, ratably engaging the rotating body or fan 2 and capable of detecting the amount of unbalances when fan 2 is being rotated about its axis.

Fan 2 is positioned in a horizontal or vertical direction over the detecting base 18 which is responsive to the unbalanced centrifugal forces present in the rotating fan.

Rotation of fan 2 can be driven by the already mentioned angular-positioning member 13 applicable to hub 4 of fan 2, on the opposite side with respect to the detecting base 18.

Identification of where unbalances are, and in general of the position of fan 2, is carried out by the presence in the measuring unit 17 of sensors 19 and counters 19a.

As viewed from FIG. 4, sensors 19 comprise photoelectric cells for example, that detect passage of blades 3 and the pulses determined by sensors 19 are counted by counters 19a.

Sensors 19 can alternatively detect passage of a reference sign identified or made in fan 2.

The measuring unit 17 and dispensing unit 7 are controlled and guided by electronic means 20 that in the case herein shown are divided into a control unit 21 of the dedicated type and a computer 22 for data supervision and collection, connected to a printer 23.

Operation of apparatus 1 is as follows.

After carrying out a measuring cycle of fan 2 by rotation of the fan itself on the measuring unit 17, the positions of the unbalances are determined and therefore the positions for application of the semifluid product 6, a not yet polymerized resin for example.

Therefore, upon positioning of nozzle 8 and fan 2 by means of support 10 and the angular-positioning member 13 respectively, the semifluid product 6 is applied by taking it from tank 11. The semifluid product 6 immediately adheres to the plastic material of fan 2 and keeps the shape resulting from the dispensing operation. However it is not able to withstand contacts or stresses.

Hardening of the applied product is activated or accelerated by the stabilizing unit 14.

If a not yet polymerized resin has been selected, hardening takes place by polymerization and polymerization is catalyzed by exposure to ultraviolet rays, for example.

Preferably fan 2 is rotated through about 180 degrees to bring the resin close to the terminal end of the optical fiber bundle 16.

After a few seconds' exposure (two to six seconds, just as an indication), the resin is sufficiently hardened so that it can withstand a test for unbalance verification. Full hardening occurs in the following hours.

The process for balancing a rotating body by material addition is the following.

First a measured quantity of material to be polymerized is applied to the unbalance regions, and then said material is caused to polymerize immediately after its application.

Preferably the material to be polymerized is applied in the form of circumferential strips or threads: it is dispensed in a continuous manner on fan 2 while the same is being rotated.

In addition application of the material to be polymerized takes place on a fan region spaced apart from that where catalyzing of the polymerization occurs, but placed in the same circumferential trajectory imposed by the rotating body.

The invention achieves important advantages.

In fact the balancing operations in accordance with the invention can be carried out in a completely automated manner in spite of the multiplicity of sizes and shapes of the fans or the like to be balanced.

In addition, the obtained balancing can be very precise, since dispensing of the added material can be continuous and vary within limits, following modalities at will.

It is also to be noted that the applied resin strips are homogeneous with the plastic material forming the fans and that they adhere without requiring holes to be made.

Due to the rounded and thin profile of the added material and to the circumferential extension and possible positioning of same at enclosed corners, either noise or an important resistance to the air flow cannot be generated.

Achievement of these results has been possible due to the original selection of the added material, its distribution in a thin and long thread, and its quick hardening induced by a catalyst.

The invention also highlights specific technical solutions simplifying the apparatus and making it capable of easily adapting to the most different fans.

By way of example it is mentioned the technical solution of keeping nozzle 8 fixed and rotating fan 2 during dispensing. In this way the overall structure is simplified and dispensing is carried out by use of the angular-positioning member 13 which is already present when the rotating bodies, in particular fans, are connected with a measuring unit 17.

Also advantageous is the technical solution of arranging a stabilizing unit 14 in which the radiation flow causing hardening is conveyed by means of optical fibers. In this way a very precise action is obtained and at the same time the radiation flow can be immediately and easily positioned again for adaptation to rotating bodies of different sizes and shapes.

It is also pointed out that the technical solution of carrying out dispensing and hardening of the resin at points spaced apart from each other but located in the same circumferential trajectory enables any structural or operating interference between the dispensing unit 7 and stabilizing unit 14 to be prevented even in the case of rotating bodies of small sizes, while a precise and substantially automatic intervention of said units is ensured.

In addition the apparatus is quite compatible and associable with a measuring unit 17 ratably engaging the rotating body and adapted to detect the amount of unbalances of said body, so that the measuring operation and the balancing intervention immediately follow each other.

1. An apparatus for balancing a rotating body by material addition, comprising dispensing means for supplying a balancing material to be applied to at least one region of said rotating body, said balancing material consisting in a semifluid product (6) susceptible of being dried and said dispensing means comprising a dispensing unit (7) for supplying measured quantities (9) of said semifluid product (6).

2. The apparatus as claimed in claim 1, wherein said semifluid product (6) is an unpolymerized resin.

3. The apparatus as claimed in claim 1, wherein said dispensing unit (7) comprises a nozzle (8) designed to dispense said semifluid product (6), a support (10) carrying said nozzle (8) and adapted to position it close to said rotating body, a tank (11) for said semifluid product (6), and a feeder device (12) designed to convey measured quantities of said semifluid product (6) to said nozzle (8).

4. The apparatus as claimed in claim 1, where actuating members adapted to impose a relative movement between said dispensing unit (7) and rotating body are provided, so that measured quantities (9) in the form of a strip and extending in a circumferential direction are made.

5. The apparatus as claimed in claim 4, wherein said actuating members comprise an angular-positioning member (13) active on said rotating body.

6. The apparatus as claimed in claim 1, wherein a stabilizing unit (14) is provided which is susceptible of drying said semifluid product (6) after dispensing of same.

7. The apparatus as claimed in claim 6, wherein said semifluid product (6) is an unpolymerized resin and wherein said stabilizing unit (14) is suitable to catalyze polymerization of said resin and comprises a source (15) designed to emit a catalyzing radiation towards said semifluid product already dispensed.

8. The apparatus as claimed in claim 7, wherein said source (15) is active in the direction of a region of said rotating body which is spaced apart from the action region of said dispensing unit (7) and placed in the same circumferential trajectory of said rotating body.

9. The apparatus as claimed in claim 7, wherein said stabilizing unit (14) comprises an optical fiber bundle (16) adapted to convey said catalyzing radiation and to be positioned and moved close to said rotating body.

10. The apparatus as claimed in claim 1, wherein a measuring unit (17) is provided which comprises a detecting base (18) ratably engaging said rotating body and designed to detect the amount of unbalances of the latter, an angular-positioning member (13) adapted to rotate said rotating body on said detecting base (18), and sensors (19) and counters (19a) for detecting the position of said rotating body and of said unbalances.

11. A process for balancing a rotating body by material addition, consisting in locally applying measured quantities of said material to be polymerized to said rotating body, and in polymerizing said material after application of same to said rotating body.

12. The process as claimed in claim 11, wherein said material to be polymerized is applied in the form of circumferential strips.

13. The process as claimed in claim 11, wherein said material is dispensed in a continuous manner on said rotating body while the same is being rotated.

14. The process as claimed in claim 11, wherein application of material to be polymerized and polymerization of same are carried out at regions spaced apart from each other and disposed along the same circumferential trajectory, and wherein passage of said material from one station to the other takes place by rotation of said rotating body.
